(19) United States
(12) Patent Application Publication
(10) Pub. No.: US 2006/0011363 A1
(43) Pub. Date: Jan. 19, 2006

(54) Pneumatic wrench having enhanced strength

(76) Inventor: Hsin Ho Chang, Taichung City (TW)

Correspondence Address: CHARLES E. BAXLEY, ESQ., 90 JOHN STREET, THIRD FLOOR, NEW YORK, NY, 10038, US

(21) Appl. No.: 10/895,206

(22) Filed: Jul. 19, 2004

(51) Int. Cl. B25D 15/00

(52) U.S. Cl. 173/93.5

(57) ABSTRACT

A pneumatic wrench includes a pneumatic motor, a striking portion, and a drive shaft. The striking portion includes a support seat, and a hammer pivotally mounted in the support seat by a pivot shaft. Thus, the pivot shaft mounted between the hammer and the support seat is formed with an enlarged portion that withstands a larger reaction applied on the hammer due to the striking action of the hammer, thereby enhancing the structural strength of the pneumatic wrench.

### BACKGROUND OF THE INVENTION

1. Field of the Invention

The present invention relates to a pneumatic wrench, and more particularly to a pneumatic wrench having an enhanced strength.

2. Description of the Related Art

A conventional pneumatic wrench in accordance with the prior art shown in FIGS. 4 and 5 comprises a pneumatic motor 10, a striking portion 20, and a drive shaft 30. The striking portion 20 is driven by the pneumatic motor 10 to rotate in the normal direction and the reverse direction to drive the drive shaft 30 to rotate, so that the drive shaft 30 is rotated to rotate a socket (not shown) mounted on the drive shaft 30 so as to drive and rotate a screw member, such as a bolt, nut or the like.

The pneumatic motor 10 includes a cylinder 11, a vane 12 mounted in the cylinder 11, a rotor 15 mounted in the cylinder 11, and a toothed shaft 16 mounted on the rotor 15. The striking portion 20 includes a support seat 21, an actuating shaft 22 mounted on the support seat 21 and engaged with the toothed shaft 16 of the pneumatic motor 10, an eccentric portion 23 formed on an end of the actuating shaft 22 and mounted in the support seat 21, and a hammer 26 pivotally mounted in the support seat 21 by a pivot shaft 25 and having a periphery formed with an operation recess 28. The hammer 26 is formed with a pivot hole 27 mounted on the pivot shaft 25. The support seat 21 has two end faces each formed with a through hole 24 for mounting the pivot shaft 25. The drive shaft 30 has a first end mounted in the support seat 21 and formed with an engaging portion 35 engaged with the hammer 26 and formed with driven recess 36 aligning with the operation recess 28 of the hammer 26. The drive shaft 30 has a second end formed with a mounting portion 31 for mounting a socket (not shown).

In operation, after the compressed air enters the cylinder 11 of the pneumatic motor 10, the vane 12 and the rotor 15 are operated to rotate the toothed shaft 16 which rotates the actuating shaft 22, so that the support seat 21 is rotated in the normal direction and the reverse direction to drive the hammer 26 to move. At this time, the eccentric portion 23 of the actuating shaft 22 drives the hammer 26 to strike the drive shaft 30 so as to drive the drive shaft 30 to rotate, so that the drive shaft 30 is rotated to rotate the socket (not shown) mounted on the mounting portion 31 of the drive shaft 30 so as to drive and rotate a screw member, such as a bolt, nut or the like.

However, the hammer 26 is pivoted to strike the drive shaft 30 when the support seat 21 is rotated each time, so that the pivot shaft 25 is subjected to a larger reaction, and the stress is concentrated on the pivot shaft 25, thereby easily deforming the pivot shaft 25 during a long-term utilization, and thereby decreasing the lifetime of the pivot shaft 25. In addition, the pivot shaft 25 is easily deformed during a long-term utilization, so that the hammer 26 is not operated smoothly, thereby affecting operation of the conventional pneumatic wrench.

### SUMMARY OF THE INVENTION

The present invention is to mitigate and/or obviate the disadvantage of the conventional pneumatic wrench.

The primary objective of the present invention is to provide a pneumatic wrench having an enhanced strength.

Another objective of the present invention is to provide a pneumatic wrench, wherein the pivot shaft mounted between the hammer and the support seat is formed with an enlarged portion that withstands a larger reaction applied on the hammer due to the striking action of the hammer, thereby enhancing the structural strength of the pneumatic wrench.

A further objective of the present invention is to provide a pneumatic wrench, wherein the enlarged portion of the pivot shaft withstands a larger reaction so as to prevent the pivot shaft from being deformed due to the larger reaction, so that the pivot shaft is operated smoothly.

A further objective of the present invention is to provide a pneumatic wrench, wherein the enlarged portion of the pivot shaft enhances the structural strength of the pneumatic wrench, thereby increasing the lifetime of the pneumatic wrench.

In accordance with one embodiment of the present invention, there is provided a pneumatic wrench, comprising a striking portion including a support seat, and a hammer pivotally mounted in the support seat by a pivot shaft, wherein:

the support seat of the striking portion has a first end face formed with a through hole and a second end face formed with an enlarged hole;

the pivot shaft has a first end inserted into the through hole of the support seat and a second end formed with an enlarged portion inserted into the enlarged hole of the support seat; and

the hammer of the striking portion has first end formed with a shaft hole mounted on the pivot shaft and a second end formed with an enlarged hole mounted on the enlarged portion of the pivot shaft.

In accordance with one embodiment of the present invention, there is provided a pneumatic wrench, comprising a striking portion including a support seat, a first hammer pivotally mounted in the support seat by a first pivot shaft, and a second hammer pivotally mounted in the support seat by a second pivot shaft, wherein:

the support seat has a first end face formed with a first through hole and a second through hole and a second end face formed with a first enlarged hole and a second enlarged hole;

the first pivot shaft has a first end inserted into the first through hole of the support seat and a second end formed with a first enlarged portion inserted into the first enlarged hole of the support seat;

the second pivot shaft has a first end inserted into the second through hole of the support seat and a second end formed with a second enlarged portion inserted into the second enlarged hole of the support seat;

the first hammer has first end formed with a first shaft hole mounted on the first pivot shaft and a second end formed with a first enlarged hole mounted on the first enlarged portion of the first pivot shaft; and

the second hammer has first end formed with a second shaft hole mounted on the second pivot shaft and a second end formed with a second enlarged hole mounted on the second enlarged portion of the second pivot shaft.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a pneumatic wrench in accordance with the preferred embodiment of the present invention;

FIG. 2 is a plan cross-sectional assembly view of the pneumatic wrench as shown in FIG. 1;

FIG. 3 is an exploded perspective view of a pneumatic wrench in accordance with another embodiment of the present invention;

FIG. 4 is an exploded perspective view of a conventional pneumatic wrench in accordance with the prior art; and

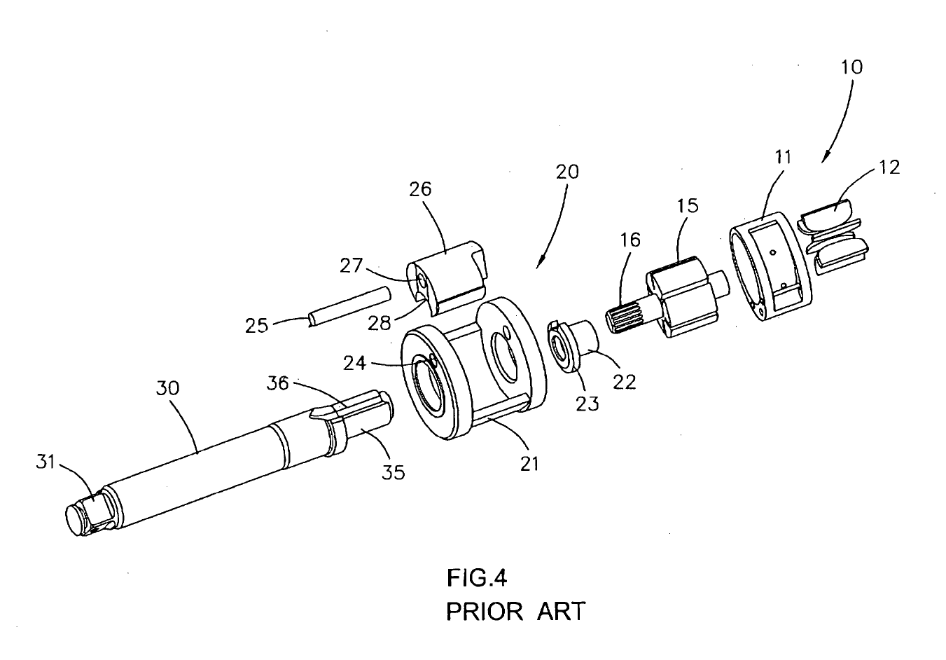

FIG. 5 is a plan cross-sectional assembly view of the conventional pneumatic wrench as shown in FIG. 4.

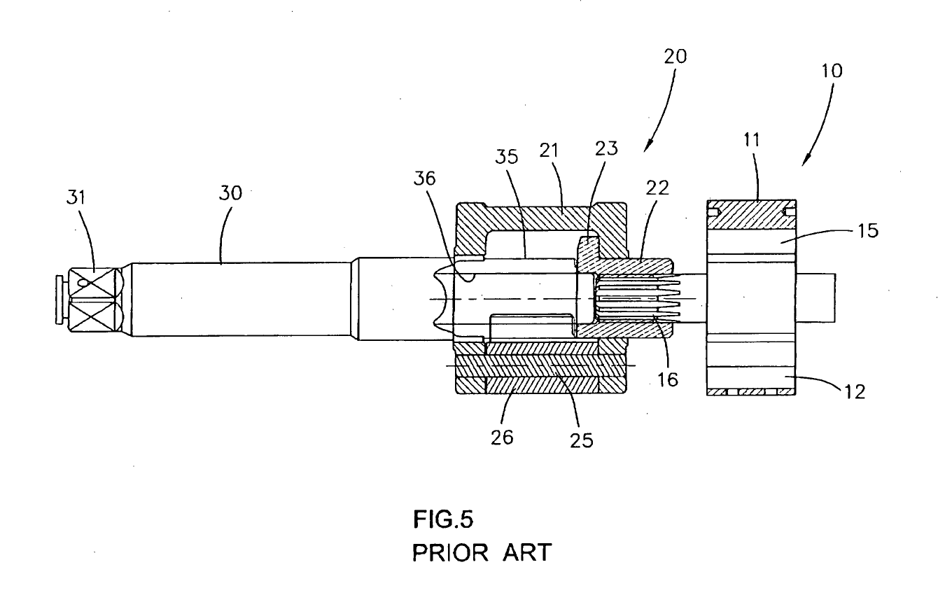

### DETAILED DESCRIPTION OF THE INVENTION

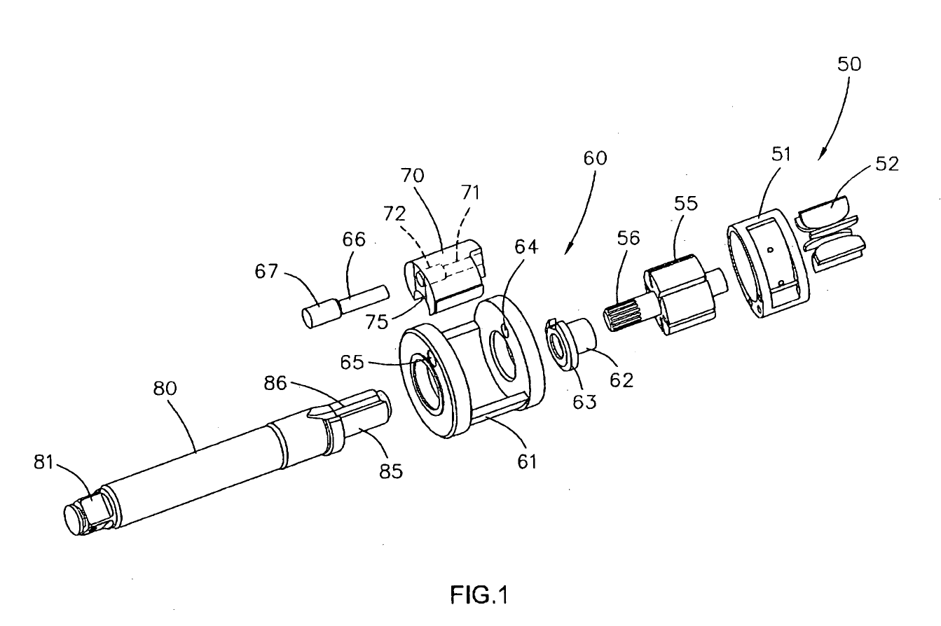

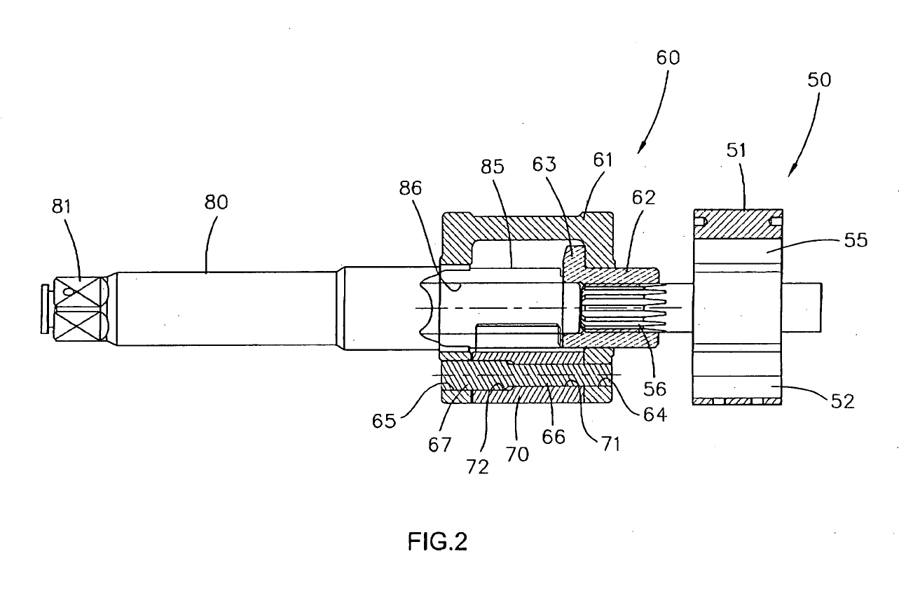

Referring to the drawings and initially to FIGS. 1 and 2, a pneumatic wrench in accordance with the preferred embodiment of the present invention comprises a pneumatic motor 50, a striking portion 60, and a drive shaft 80.

The striking portion 60 is driven by the pneumatic motor 50 to rotate in the normal direction and the reverse direction to drive the drive shaft 80 to rotate, so that the drive shaft 80 is rotated to rotate a socket (not shown) mounted on the drive shaft 80 so as to drive and rotate a screw member, such as a bolt, nut or the like.

The pneumatic motor 50 includes a cylinder 51, a vane 52 mounted in the cylinder 51, a rotor 55 mounted in the cylinder 51, and a toothed shaft 56 mounted on the rotor 55.

The striking portion 60 includes a support seat 61, an actuating shaft 62 mounted on the support seat 61 and engaged with the toothed shaft 56 of the pneumatic motor 50, an eccentric portion 63 formed on an end of the actuating shaft 62 and mounted in the support seat 61, and a hammer 70 pivotally mounted in the support seat 61 by a pivot shaft 66 and having a periphery formed with an operation recess 75.

The support seat 61 of the striking portion 60 has a first end face formed with a through hole 64 and a second end face formed with an enlarged hole 65. Preferably, the through hole 64 of the support seat 61 is co-axial with the enlarged hole 65 of the support seat 61.

The pivot shaft 66 has a first end inserted into the through hole 64 of the support seat 61 and a second end formed with an enlarged portion 67 inserted into the enlarged hole 65 of the support seat 61. Preferably, the enlarged portion 67 of the pivot shaft 66 is circular and has a diameter equal to that of the enlarged hole 65 of the support seat 61.

The hammer 70 of the striking portion 60 has first end formed with a shaft hole 71 mounted on the pivot shaft 66 and a second end formed with an enlarged hole 72 mounted on the enlarged portion 67 of the pivot shaft 66. Preferably, the enlarged hole 72 of the hammer 70 has a diameter equal to that of the enlarged portion 67 of the pivot shaft 66.

In such a manner, the pivot shaft 66 is extended through the shaft hole 71 of the hammer 70 and the through hole 64 of the support seat 61, and the enlarged portion 67 of the pivot shaft 66 is extended through the enlarged hole 65 of the support seat 61 and the enlarged hole 72 of the hammer 70.

The drive shaft 80 has a first end mounted in the support seat 61 of the striking portion 60 and formed with an engaging portion 85 engaged with the hammer 70. The engaging portion 85 of the drive shaft 80 is formed with driven recess 86 aligning with the operation recess 75 of the hammer 70 of the striking portion 60. The drive shaft 80 has a second end formed with a mounting portion 81 for mounting a socket (not shown).

In operation, after the compressed air enters the cylinder 51 of the pneumatic motor 50, the vane 52 and the rotor 55 are operated to rotate the toothed shaft 56 which rotates the actuating shaft 62, so that the support seat 61 is rotated in the normal direction and the reverse direction to drive the hammer 70 to move. At this time, the eccentric portion 63 of the actuating shaft 62 drives the hammer 70 to strike the drive shaft 80 so as to drive the drive shaft 80 to rotate, so that the drive shaft 80 is rotated to rotate the socket (not shown) mounted on the mounting portion 81 of the drive shaft 80 so as to drive and rotate a screw member, such as a bolt, nut or the like.

Accordingly, the pivot shaft 66 mounted between the hammer 70 and the support seat 61 is formed with an enlarged portion 67 that withstands a larger reaction applied on the hammer 70 due to the striking action of the hammer 70, thereby enhancing the structural strength of the pneumatic wrench. In addition, the enlarged portion 67 of the pivot shaft 66 withstands a larger reaction so as to prevent the pivot shaft 66 from being deformed due to the larger reaction, so that the pivot shaft 66 is operated smoothly. Further, the enlarged portion 67 of the pivot shaft 66 enhances the structural strength of the pneumatic wrench, thereby increasing the lifetime of the pneumatic wrench.

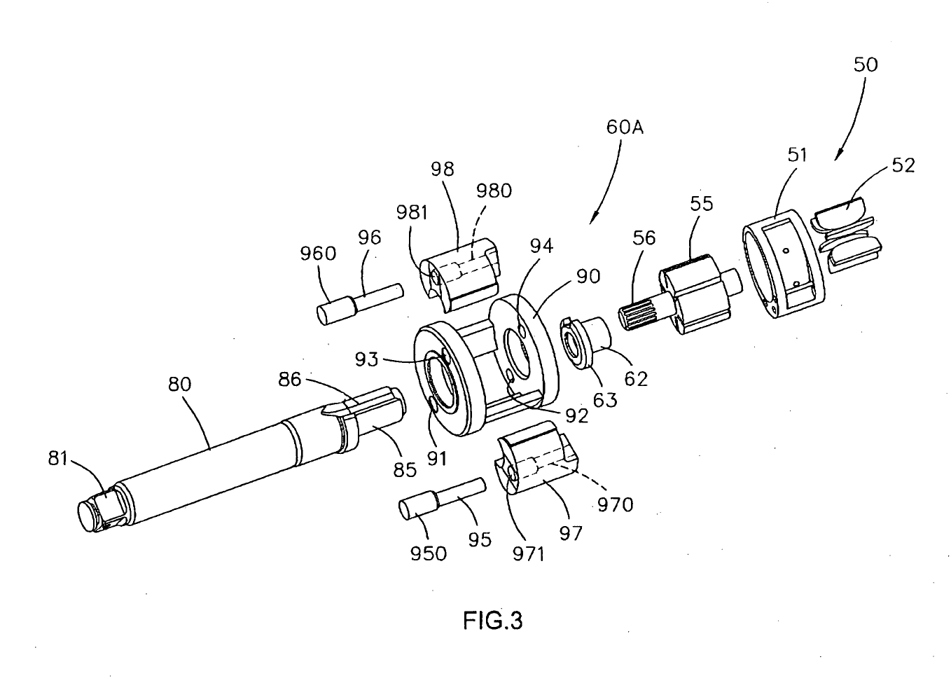

Referring to FIG. 3, the striking portion 60A includes a support seat 90, an actuating shaft 62 mounted on the support seat 90 and engaged with the toothed shaft 56 of the pneumatic motor 50, an eccentric portion 63 formed on an end of the actuating shaft 62 and mounted in the support seat 90, a first hammer 97 pivotally mounted in the support seat 90 by a first pivot shaft 95, and a second hammer 98 pivotally mounted in the support seat 90 by a second pivot shaft 96.

The support seat 90 has a first end face formed with a first through hole 92 and a second through hole 94 and a second end face formed with a first enlarged hole 91 and a second enlarged hole 93. Preferably, the first through hole 92 of the support seat 90 is co-axial with the first enlarged hole 91 of the support seat 90, and the second through hole 94 of the support seat 90 is co-axial with the second enlarged hole 93 of the support seat 90.

The first pivot shaft 95 has a first end inserted into the first through hole 92 of the support seat 90 and a second end formed with a first enlarged portion 950 inserted into the first enlarged hole 91 of the support seat 90. Preferably, the first enlarged portion 950 of the first pivot shaft 95 is circular and has a diameter equal to that of the first enlarged hole 91 of the support seat 90.

Similarly, the second pivot shaft 96 has a first end inserted into the second through hole 94 of the support seat 90 and a second end formed with a second enlarged portion 960 inserted into the second enlarged hole 93 of the support seat 90. Preferably, the second enlarged portion 960 of the second pivot shaft 96 is circular and has a diameter equal to that of the second enlarged hole 93 of the support seat 90.

The first hammer 97 has first end formed with a first shaft hole 970 mounted on the first pivot shaft 95 and a second end formed with a first enlarged hole 971 mounted on the first enlarged portion 950 of the first pivot shaft 95. Preferably, the first enlarged hole 971 of the first hammer 97 has a diameter equal to that of the first enlarged portion 950 of the first pivot shaft 95.

Similarly, the second hammer 98 has first end formed with a second shaft hole 980 mounted on the second pivot shaft 96 and a second end formed with a second enlarged hole 981 mounted on the second enlarged portion 960 of the second pivot shaft 96. Preferably, the second enlarged hole 981 of the second hammer 98 has a diameter equal to that of the second enlarged portion 960 of the second pivot shaft 96.

In such a manner, the first pivot shaft 95 is extended through the first shaft hole 970 of the first hammer 97 and the first through hole 92 of the support seat 90, and the first enlarged portion 950 of the first pivot shaft 95 is extended through the first enlarged hole 91 of the support seat 90 and the first enlarged hole 971 of the first hammer 97.

Similarly, the second pivot shaft 96 is extended through the second shaft hole 980 of the second hammer 98 and the second through hole 94 of the support seat 90, and the second enlarged portion 960 of the second pivot shaft 96 is extended through the second enlarged hole 93 of the support seat 90 and the second enlarged hole 981 of the second hammer 98.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A pneumatic wrench, comprising a striking portion including a support seat, and a hammer pivotally mounted in the support seat by a pivot shaft, wherein:
the support seat of the striking portion has a first end face formed with a through hole and a second end face formed with an enlarged hole;
the pivot shaft has a first end inserted into the through hole of the support seat and a second end formed with an enlarged portion inserted into the enlarged hole of the support seat; and
the hammer of the striking portion has first end formed with a shaft hole mounted on the pivot shaft and a second end formed with an enlarged hole mounted on the enlarged portion of the pivot shaft.

2. The pneumatic wrench in accordance with claim 1, wherein the through hole of the support seat is co-axial with the enlarged hole of the support seat.

3. The pneumatic wrench in accordance with claim 1, wherein the enlarged portion of the pivot shaft is circular and has a diameter equal to that of the enlarged hole of the support seat.

4. The pneumatic wrench in accordance with claim 1, wherein the enlarged hole of the hammer has a diameter equal to that of the enlarged portion of the pivot shaft.

5. The pneumatic wrench in accordance with claim 1, wherein the pivot shaft is extended through the shaft hole of the hammer and the through hole of the support seat.

6. The pneumatic wrench in accordance with claim 1, wherein the enlarged portion of the pivot shaft is extended through the enlarged hole of the support seat and the enlarged hole of the hammer.

7. The pneumatic wrench in accordance with claim 1, wherein the pivot shaft is mounted between the hammer and the support seat.

8. A pneumatic wrench, comprising a striking portion including a support seat, a first hammer pivotally mounted in the support seat by a first pivot shaft, and a second hammer pivotally mounted in the support seat by a second pivot shaft, wherein:
the support seat has a first end face formed with a first through hole and a second through hole and a second end face formed with a first enlarged hole and a second enlarged hole;
the first pivot shaft has a first end inserted into the first through hole of the support seat and a second end formed with a first enlarged portion inserted into the first enlarged hole of the support seat;
the second pivot shaft has a first end inserted into the second through hole of the support seat and a second end formed with a second enlarged portion inserted into the second enlarged hole of the support seat;
the first hammer has first end formed with a first shaft hole mounted on the first pivot shaft and a second end formed with a first enlarged hole mounted on the first enlarged portion of the first pivot shaft; and
the second hammer has first end formed with a second shaft hole mounted on the second pivot shaft and a second end formed with a second enlarged hole mounted on the second enlarged portion of the second pivot shaft.

9. The pneumatic wrench in accordance with claim 8, wherein the first through hole of the support seat is co-axial with the first enlarged hole of the support seat.

10. The pneumatic wrench in accordance with claim 8, wherein the second through hole of the support seat is co-axial with the second enlarged hole of the support seat.

11. The pneumatic wrench in accordance with claim 8, wherein the first enlarged portion of the first pivot shaft is circular and has a diameter equal to that of the first enlarged hole of the support seat.

12. The pneumatic wrench in accordance with claim 8, wherein the second enlarged portion of the second pivot shaft is circular and has a diameter equal to that of the second enlarged hole of the support seat.

13. The pneumatic wrench in accordance with claim 8, wherein the first enlarged hole of the first hammer has a diameter equal to that of the first enlarged portion of the first pivot shaft.

14. The pneumatic wrench in accordance with claim 8, wherein the second enlarged hole of the second hammer has a diameter equal to that of the second enlarged portion of the second pivot shaft.

15. The pneumatic wrench in accordance with claim 8, wherein the first pivot shaft is extended through the first shaft hole of the first hammer and the first through hole of the support seat.

16. The pneumatic wrench in accordance with claim 8, wherein the first enlarged portion of the first pivot shaft is extended through the first enlarged hole of the support seat and the first enlarged hole of the first hammer.

17. The pneumatic wrench in accordance with claim 8, wherein the second pivot shaft is extended through the second shaft hole of the second hammer and the second through hole of the support seat.

18. The pneumatic wrench in accordance with claim 8, wherein the second enlarged portion of the second pivot shaft is extended through the second enlarged hole of the support seat and the second enlarged hole of the second hammer.
